(19) United States
(12) Patent Application Publication
(10) Pub. No.: US 2008/0204399 A1
(43) Pub. Date: Aug. 28, 2008

(54) DRIVING METHOD FOR ELECTROPHORETIC DISPLAY

(75) Inventors: Uk-Chul CHOI, Cheonan-si (KR); Cheol-Woo PARK, Suwon-si (KR); Joo-Young KIM, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/928,332

(22) Filed: Oct. 30, 2007

(30) Foreign Application Priority Data
Feb. 27, 2007 (KR) 10-2007-0019412

(51) Int. Cl. G09G 3/34

(52) U.S. Cl. 345/107

(57) ABSTRACT

A driving method for an electrophoretic display including first electrodes, a second electrode, and electrophoretic particles positioned in pixel areas, includes applying a reset voltage to the particles, applying a reset compensation voltage having an opposite polarity to that of the reset voltage to the particles after applying the reset voltage, applying an image displaying compensation voltage having a same polarity as the reset compensation voltage to the particles positioned in at least one of the pixel areas after applying the reset compensation voltage, and applying an image displaying voltage having an opposite polarity to that of the image displaying compensation voltage to the particles positioned in the at least one of the pixel areas. Accordingly, the pixel electrode may be refreshed without inversed images such that the display performance of the electrophoretic display may be improved.

This application claims priority to Korean Patent Application No. 10-2007-0019412, filed on Feb. 27, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a driving method for an electrophoretic display. More particularly, the present invention relates to a driving method improving display performance of an electrophoretic display.

(b) Description of the Related Art

Recently, flat panel displays such as liquid crystal displays (“LCDs”), organic light emitting diode (“OLED”) displays, electrophoretic displays, and so on are being substituted for conventional cathode ray tubes (“CRTs”).

Among the flat panel displays, the electrophoretic display includes a thin film transistor (“TFT”) array panel including pixel electrodes connected to TFTs, a common electrode panel including a common electrode, and electrophoretic particles interposed between the two panels, having positive or negative charges, and moving between the pixel electrodes and the common electrode.

According to a known method of displaying images for an electrophoretic display, a driving unit supplies a common voltage to the common electrode and data voltages that are higher or lower than the common voltage to each pixel electrode. The difference between the common voltage and the data voltage forms a positive or negative driving voltage to electrophoretic particles located in each pixel area. The electrophoretic particles having positive or negative charges are moved to the pixel electrode or the common electrode depending on the driving voltage. Here, the movement of the electrophoretic particles is also controlled by the duration of the driving voltages.

Driving voltages having different durations are supplied to each pixel area, and the electrophoretic particles in each pixel area are moved and arranged in a different manner. External light incident on the electrophoretic display is absorbed or reflected by the electrophoretic particles that are moved and arranged in a different manner at each pixel area, and thereby the electrophoretic display displays black, white, or various colors.

### BRIEF SUMMARY OF THE INVENTION

Within an electrophoretic display, driving voltages are supplied to the electrophoretic particles repeatedly such that electric charges may be accumulated at each pixel electrode and the accumulated electric charges cause incidental image. For the prevention of the incidental image, the accumulated electric charges must be removed at regular intervals to refresh the pixel electrode.

The present invention provides a driving method for an electrophoretic display having advantages of refreshing a pixel electrode and improving displaying performance of an electrophoretic display.

Exemplary embodiments of a driving method for an exemplary electrophoretic display according to the present invention, wherein the electrophoretic display includes a plurality of first electrodes, a second electrode, and electrophoretic particles positioned in a plurality of pixel areas between the first electrodes and the second electrode, includes applying an initial driving voltage to the electrophoretic particles positioned in the plurality of the pixel areas for a set time, applying a reset voltage to the electrophoretic particles for a set time, applying a reset compensation voltage having an opposite polarity to the reset voltage to the electrophoretic particles for a set time after applying the reset voltage, applying an image displaying compensation voltage having a same polarity as the reset compensation voltage to the electrophoretic particles positioned in at least one of the pixel areas for a set time after applying the reset compensation voltage, and applying an image displaying voltage having the opposite polarity to that of the image displaying compensation voltage to the electrophoretic particles positioned in the at least one of the pixel areas for a set time.

The image displaying voltage may be applied to the electrophoretic particles positioned in the at least one of the pixel areas supplied with the image displaying compensation voltage after applying the image displaying compensation voltage.

The image displaying voltage may be applied to the electrophoretic particles positioned in the at least one of the pixel areas before applying the reset voltage. The image displaying compensation voltage may be applied to the electrophoretic particles positioned in the pixel areas supplied with the image displaying voltage.

A value of integrating the reset voltage with applying time thereof may be substantially same as that of integrating the reset compensation voltage with applying time thereof.

A value of integrating the image displaying compensation voltage with applying time thereof may be substantially same as that of integrating the image displaying voltage with applying time thereof.

The reset voltage and the reset compensation voltage may have a substantially same magnitude.

The image displaying compensation voltage and the image displaying voltage may have a substantially same magnitude.

The reset voltage and the image displaying voltage may have a substantially same magnitude.

The pixel areas may display a first color image by applying the reset voltage, may display a fourth color image by applying the reset compensation voltage, may display the fourth color image by applying the image displaying compensation voltage, and may display at least one color image of the first color image, a second color image, a third color image, and the fourth color image by applying the image displaying voltage.

The first color image may be a black color image, and the fourth color image may be a white color image, and the second color image may be brighter than the first color image and the third color image may be brighter than the second color image.

An applying time of the reset voltage may be a first time needed for a plurality of the pixel areas to display the first color image, an applying time of the reset compensation voltage may be a second time needed for a plurality of the pixel areas to display the fourth color image, an applying time of the image displaying compensation voltage may be a third time, and an applying time of the image displaying voltage may be a fourth time needed for a plurality of the pixel areas to display at least one color image of the first color image to the fourth color image, and a value of integrating the image displaying compensation voltage with the third time may be substantially same as that of integrating the image displaying compensation voltage with the fourth time. The first time may be substantially same as the second time. The third time may be substantially same as the fourth time.

The pixel areas may display a first color image by applying the reset voltage, respectively, may display a sixteenth color image by applying the reset compensation voltage, respectively, may display the sixteenth color image by applying the image displaying compensation voltage, respectively, and may display one color image of the first color image to the sixteenth color image by applying the image displaying voltage, respectively.

The first color image may be a black color image, the sixteenth color image may be a white color image, and color images displayed by the pixel areas may become brighter from the first color image to the sixteenth color image.

An applying time of the reset voltage may be a first time needed for a plurality of the pixel areas to display the first color image, an applying time of the reset compensation voltage may be a second time needed for a plurality of the pixel areas to display the sixteenth color image, an applying time of the image displaying compensation voltage may be a third time, and an applying time of the image displaying voltage may be a fourth time needed for a plurality of the pixel areas to display at least one color image of the first color image to the sixteenth color image, and a value of integrating the image displaying compensation voltage with the third time may be substantially same as that of integrating the image displaying compensation voltage with the fourth time. The first time may be substantially same as the second time. The third time may be substantially same as the fourth time.

Exemplary embodiments of a driving method for an exemplary electrophoretic display according to the present invention, wherein the electrophoretic display includes pixel electrodes, a common electrode, and electrophoretic particles positioned in a plurality of pixel areas between the pixel electrodes and the common electrode, the driving method includes supplying the electrophoretic particles positioned in the pixel areas with a reset voltage and a reset compensation voltage of opposite polarities, each supplied for a substantially same amount of time, and supplying the pixel areas with an image displaying compensation voltage and an image displaying voltage of opposite polarities each for a substantially same amount of time, wherein negative or positive electric charges are not accumulated at the pixel electrodes to prevent incidental images.

### BRIEF DESCRIPTION OF THE DRAWINGS

The above and other features and advantages of the present invention will become apparent and more readily appreciated from the following description of the exemplary embodiments, taken in conjunction with the accompanying drawings, in which:

FIG. 1 is a layout view of an exemplary electrophoretic display controlled by an exemplary driving method according to an exemplary embodiment of the present invention;

FIG. 2 is a sectional view of the exemplary electrophoretic display shown in FIG. 1 taken along line II-II;

FIG. 3 is a sectional view of the exemplary electrophoretic display shown in FIG. 1 representing a fourth image displayed in a pixel area for explaining an exemplary method for displaying the fourth image during driving of the exemplary electrophoretic display according to an exemplary embodiment of the present invention;

FIG. 4 is a plan view representing the fourth image displayed at the pixel area of the exemplary electrophoretic display shown in FIG. 3;

FIG. 5 is a sectional view of the exemplary electrophoretic display shown in FIG. 1 representing a third image displayed in a pixel area for explaining an exemplary method for displaying the third image during driving the exemplary electrophoretic display according to an embodiment of the present invention;

FIG. 6 is a plan view representing the third image displayed at the pixel area of the exemplary electrophoretic display shown in FIG. 5;

FIG. 7 is a sectional view of the exemplary electrophoretic display shown in FIG. 1 representing a second image displayed in a pixel area for explaining an exemplary method for displaying the second image during driving of the exemplary electrophoretic display according to an embodiment of the present invention;

FIG. 8 is a plan view representing the second image displayed at the pixel area of the exemplary electrophoretic display shown in FIG. 7;

FIG. 9 is a sectional view of the exemplary electrophoretic display shown in FIG. 1 representing a first image displayed in a pixel area for explaining an exemplary method for displaying the first image during driving of the exemplary electrophoretic display according to an embodiment of the present invention;

FIG. 10 is a plan view representing the first image displayed at the pixel area of the exemplary electrophoretic display shown in FIG. 9;

FIG. 11 is a drawing representing driving voltages supplied to a pixel area of the exemplary electrophoretic display in process of time for explaining an exemplary method for driving the exemplary electrophoretic display according to an embodiment of the present invention; and

FIG. 12 is a drawing representing driving voltages supplied to a pixel area of the exemplary electrophoretic display in process of time for explaining an exemplary method for driving the electrophoretic display according to another embodiment of the present invention.

### DETAILED DESCRIPTION OF THE INVENTION

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

A driving method for an electrophoretic display according to various exemplary embodiments of the present invention will now be described with reference to the accompanying drawings.

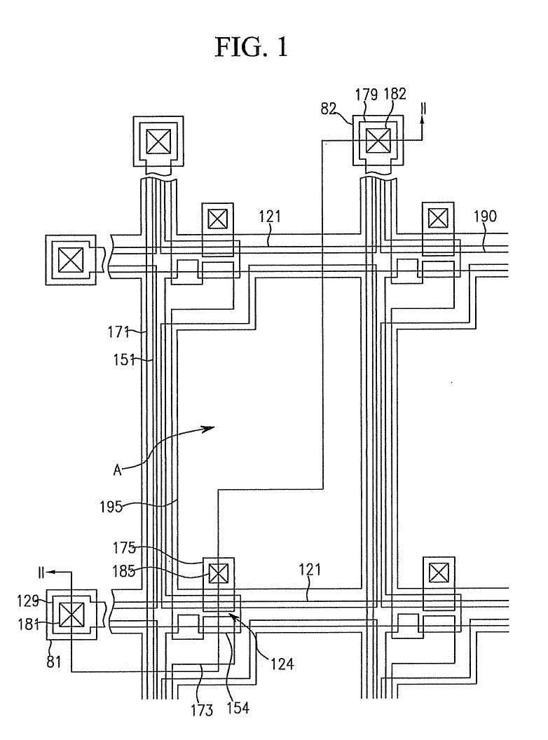

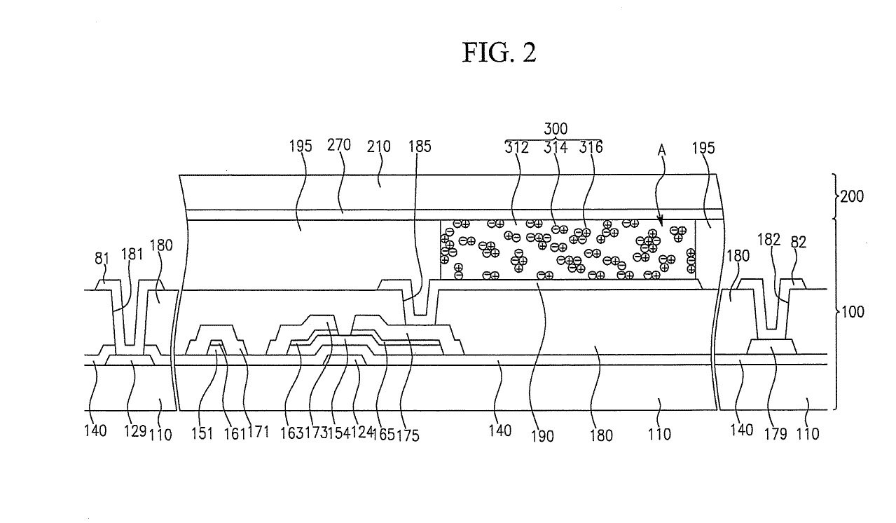

First, an exemplary electrophoretic display according to an exemplary embodiment of the present invention will be described in detail with reference to FIG. 1 and FIG. 2, before describing an exemplary driving method for the exemplary electrophoretic display according to an exemplary embodiment of the present invention.

FIG. 1 is a layout view of an exemplary electrophoretic display controlled by an exemplary driving method according to an exemplary embodiment of the present invention, and FIG. 2 is a sectional view of the exemplary electrophoretic display shown in FIG. 1 taken along line II-II.

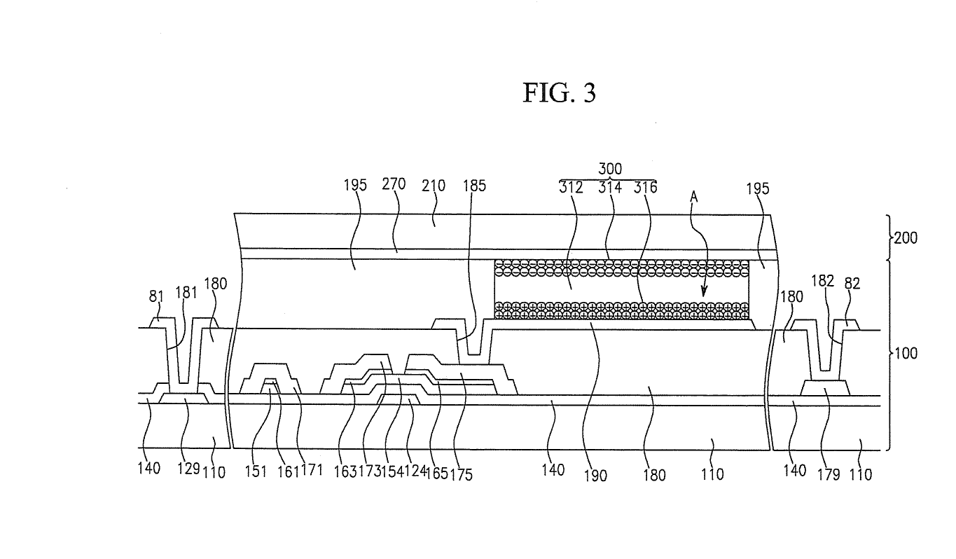

Referring to FIG. 1 and FIG. 3, an exemplary electrophoretic display according to one exemplary embodiment of the present invention includes a thin film transistor (“TFT”) array panel 100, a common electrode panel 200, and an electrophoretic member 300 disposed between the panels 100 and 200.

First, the TFT array panel 100 will be described.

As shown in FIG. 1 and FIG. 2, a plurality of gate lines 121 are formed on an insulation substrate 110 made of a material such as transparent glass or plastic. The gate lines 121 transmit gate signals and extend substantially in a transverse direction, a first direction. Each of the gate lines 121 includes a plurality of gate electrodes 124 and an end portion 129 having a large area for contact with another layer or an external driving circuit.

The gate lines 121 are preferably made of an aluminum Al-containing metal such as Al and an Al alloy, a silver Ag-containing metal such as Ag and a Ag alloy, a copper Cu-containing metal such as Cu and a Cu alloy, a molybdenum Mo-containing metal such as Mo and a Mo alloy, chromium Cr, tantalum Ta, titanium Ti, etc. The gate lines 121 may include two conductive films, a lower film and an upper film disposed thereon, which have different physical characteristics. The upper film may be made of low resistivity metal including an Al-containing metal such as Al and an Al alloy for reducing signal delay or voltage drop of the gate lines 121, and the lower film may be made of material such as a Mo-containing metal such as Mo and a Mo alloy, or Cr, which has good physical, chemical, and electrical contact characteristics with other materials such as indium tin oxide (“ITO”) or indium zinc oxide (“IZO”). One exemplary embodiment of the combination of the two films includes a lower Cr film and an upper Al-Nd (alloy) film.

In addition, the gate lines 121 may include a single layer preferably made of the above-described materials, or may have a triple-layered structure including the above-described materials. While particular exemplary embodiments have been described, other various metals or conductors may be used for the gate lines 121.

A gate insulating layer 140 preferably made of silicon nitride (SiNx) or silicon oxide (SiOx) is formed on the gate lines 121, and on exposed portions of the insulation substrate 110.

A plurality of semiconductor stripes 151 preferably made of hydrogenated amorphous silicon (“a-Si”) or polysilicon are formed on the gate insulating layer 140. Each of the semiconductor stripes 151 extends substantially in the longitudinal direction, a second direction substantially perpendicular to the first direction, and includes a plurality of projections 154 branched out toward the gate electrodes 124. The semiconductor stripes 151 become wide near the gate lines 121 such that the semiconductor stripes 151 cover large areas of the gate lines 121.

A plurality of ohmic contact stripes and islands 161 and 165 are formed on the semiconductor stripes 151. The ohmic contacts 163 and 165 are preferably made of n+ hydrogenated a-Si heavily doped with an n-type impurity such as phosphorous, or they may be made of silicide. Each of the ohmic contact stripes 161 includes a plurality of projections 163, and the projections 163 and the ohmic contact islands 165 are located in pairs on the projections 154 of the semiconductor stripes 151.

A plurality of data lines 171 and a plurality of drain electrodes 175 are formed on the ohmic contacts 161 and 165 and the gate insulating layer 140.

The data lines 171 transmit data signals and extend substantially in the longitudinal direction, the second direction, to intersect the gate lines 121. Each data line 171 includes a plurality of source electrodes 173 projecting toward the gate electrodes 124 and which may be curved like a character J and an end portion 179 having a large area for contact with another layer or an external driving circuit. The drain electrodes 175 are separated from the data lines 171 and disposed opposite the source electrodes 173 with respect to the gate electrodes 124.

The data lines 171 and the drain electrodes 175 may be made of refractory metal such as Cr, Mo, Ta, Ti, or alloys thereof. However, they may have a multi-layered structure including a refractory metal film (not shown) and a low resistivity film (not shown). Exemplary embodiments of the multi-layered structure include a double-layered structure including a lower Cr/Mo (alloy) film and an upper Al (alloy) film, and a triple-layered structure of a lower Mo (alloy) film, an intermediate Al (alloy) film, and an upper Mo (alloy) film. However, while particular exemplary embodiments have been described, the data lines 171 and the drain electrodes 175 may be made of other various metals or conductors.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The ohmic contacts 161 and 165 are interposed only between the underlying semiconductor stripes 151 and the overlying conductors 171 and 175 thereon, and reduce the contact resistance therebetween.

Although the semiconductor stripes 151 are narrower than the data lines 171 at most places, the width of the semiconductor stripes 151 becomes large near the gate lines 121 as described above, to smooth the profile of the surface, thereby preventing the disconnection of the data lines 171. However, the semiconductor stripes 151 including projections 154 include some exposed portions, which are not covered with the data lines 171 and the drain electrodes 175, such as portions located between the source electrodes 173 and the drain electrodes 175.

In another exemplary embodiment of the present invention, unlike the TFT array panel shown in FIG. 1 and FIG. 2, the semiconductor stripe layer 151 may have substantially the same planar shape as the data line 171 and the drain electrode 175 along with the underlying ohmic contacts 161 and 165.

In one exemplary embodiment of the invention, the semiconductor stripe layer 151 and ohmic contacts 161 and 165 may be formed along with the data line 171 and the drain electrode 175 using just one mask.

A passivation layer 180 is formed on the data lines 171, the drain electrodes 175, and the exposed portions of the semiconductor stripes 151, and on exposed portions of the gate insulating layer 140. The passivation layer 180 may be made of an inorganic insulator or organic insulator and it may have a flat top surface. Examples of the inorganic insulator include silicon nitride and silicon oxide. The organic insulator may have photosensitivity and a dielectric constant less than about 4.0. The passivation layer 180 may also include a lower film of an inorganic insulator and an upper film of an organic insulator, such that it takes the excellent insulating characteristics of the organic insulator while preventing the exposed portions of the semiconductor stripes 151 from being damaged by the organic insulator.

The passivation layer 180 has a plurality of contact holes 181, 182, and 185 exposing the end portions 129 of the gate lines 121, the end portions 179 of the data lines 171, and the drain electrodes 175, respectively.

A plurality of pixel electrodes 190 and a plurality of contact assistants 81 and 82 are formed on the passivation layer 180. They are preferably made of a transparent conductor such as ITO or IZO or a reflective conductor such as Ag, Al, or alloys thereof.

The pixel electrodes 190 are physically and electrically connected to the drain electrodes 175 through the contact holes 185 such that the pixel electrodes 190 receive data voltages from the drain electrodes 175 and supply the data voltages to respective electrophoretic members 300.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices such as a driver integrated circuit.

A plurality of partitioning walls 195 are formed on the passivation layer 180. They include at least one of an organic insulator material and an inorganic insulator material and separate each of the pixel electrodes 190. The partitioning walls 195 surround the peripheries of the pixel electrodes 190 to create a bank that may define pixel areas where a dispersion medium 312 of the electrophoretic member 300 is filled.

Next, the common electrode panel 200 will be described.

The common electrode panel 200 is opposed to the TFT array panel 100, and includes a transparent insulation substrate 210 and a common electrode 270 formed on the insulation substrate 210.

The common electrode 270 is a transparent electrode made of ITO or IZO, and applies a common voltage to respective electrophoretic particles 314 and 316 of the electrophoretic members 300.

The common electrode 270 applying a common voltage and the pixel electrodes 190 applying a data voltage changes the position of the electrophoretic particles 314 and 316 by applying a driving voltage to the respective electrophoretic particles 314 and 316, thereby displaying images of desired black and white luminance or colors.

Next, the electrophoretic members 300 located in respective pixel areas A will be described.

The respective electrophoretic members 300 include a transparent dispersion medium 312 and a plurality of first electrophoretic particles 314 and a plurality of second electrophoretic particles 316 dispersed in the dispersion medium 312.

The first electrophoretic particles 314 are electrification particles that have a white color for reflecting external light to show a white color and have negative charges. The second electrophoretic particles 316 are electrification particles that have a black color for absorbing external light to show a black color and have positive charges. In an alternative exemplary embodiment, the first electrophoretic particles 314 and the second electrophoretic particles 316 may have positive charges and negative charges, respectively, contrary to the above.

In another alternative exemplary embodiment, the electrophoretic member 300 may include a plurality of capsules enclosing the respective electrophoretic particles 314 and 315 and the dispersion medium 312. Here, the partitioning walls 195 of the TFT array panel 100 may be omitted, and the electrophoretic member 300 may be fixed by a binder or fixing film between the display panels 100 and 200.

Now, an exemplary method for displaying images having four different gray levels of the exemplary electrophoretic display according to an exemplary embodiment of the present invention will be described referring to FIG. 3 to FIG. 10.

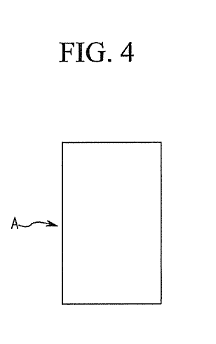

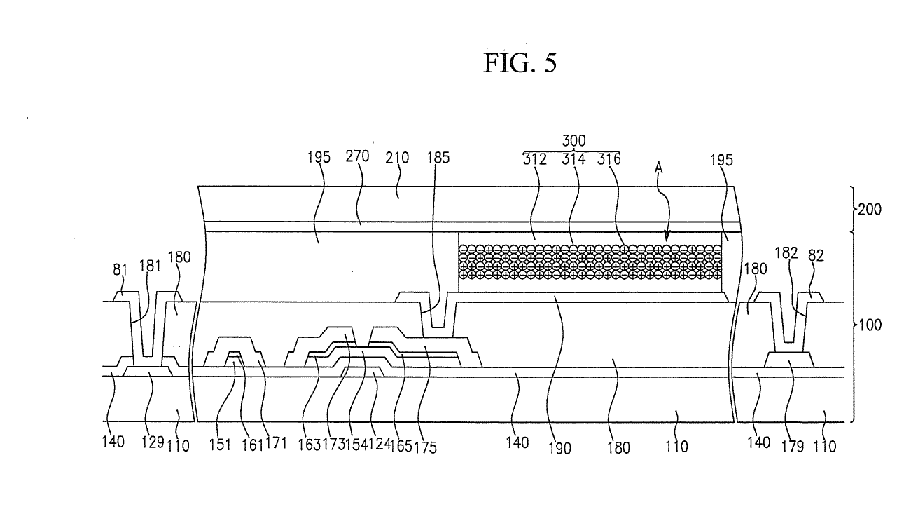

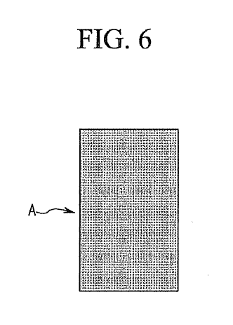

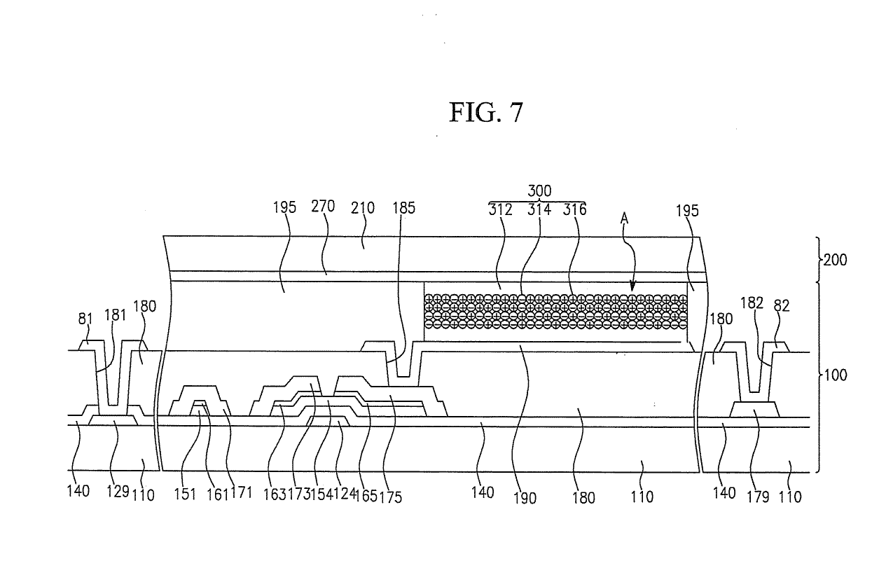

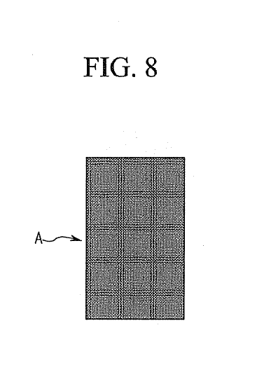

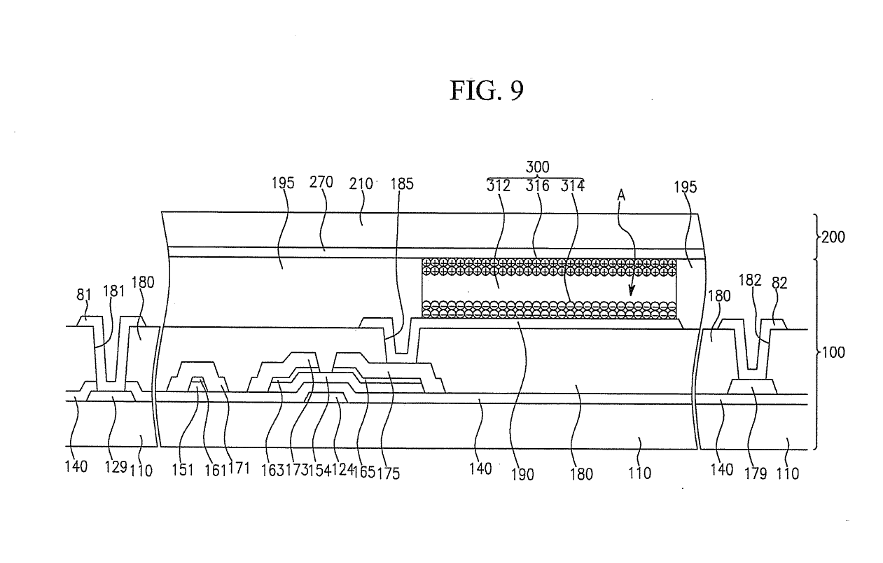

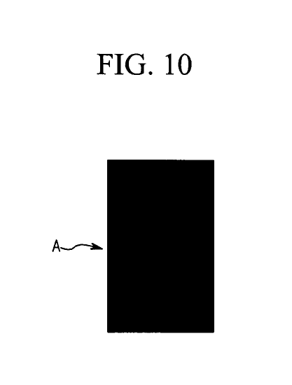

FIG. 3 is a sectional view of the exemplary electrophoretic display shown in FIG. 1 representing a fourth image displayed in a pixel area for explaining an exemplary method for displaying the fourth image during driving of the exemplary electrophoretic display according to an exemplary embodiment of the present invention, FIG. 4 is a plan view representing the fourth image displayed at the pixel area of the exemplary electrophoretic display shown in FIG. 3, FIG. 5 is a sectional view of the exemplary electrophoretic display shown in FIG. 1 representing a third image displayed in a pixel area for explaining an exemplary method for displaying the third image during driving of the exemplary electrophoretic display according to an exemplary embodiment of the present invention, FIG. 6 is a plan view representing the third image displayed at the pixel area of the exemplary electrophoretic display shown in FIG. 5, FIG. 7 is a sectional view of the exemplary electrophoretic display shown in FIG. 1 representing a second image displayed in a pixel area for explaining an exemplary method for displaying the second image during driving of the exemplary electrophoretic display according to an exemplary embodiment of the present invention, FIG. 8 is a plan view representing the second image displayed at the pixel area of the exemplary electrophoretic display shown in FIG. 7, FIG. 9 is a sectional view of the exemplary electrophoretic display shown in FIG. 1 representing a first image displayed in a pixel area for explaining an exemplary method for displaying the first image during driving of the exemplary electrophoretic display according to an exemplary embodiment of the present invention, and FIG. 10 is a plan view representing the first image displayed at the pixel area of the exemplary electrophoretic display shown in FIG. 9.

The driving voltages, which are the differences between the common voltage applied to the common electrode 270 and the data voltages applied to the respective pixel electrodes 190, are supplied to the electrophoretic particles 314 and 316 of respective pixel areas A. Here, the movement of the electrophoretic particles 314 and 316 is controlled by the duration of the driving voltages supplied to the electrophoretic particles 314 and 316 of the respective pixel areas A such that the electrophoretic particles 314 and 316 are arranged in a number of different forms, such as four different forms. Along with the arrangement of the electrophoretic particles 314 and 316, the respective pixel areas A may display four gray images. An initial driving voltage may be applied to the electrophoretic particles positioned in the plurality of the pixel areas for a predetermined time.

As shown in FIG. 3, the first electrophoretic particles 314 of the respective pixel areas A are positioned adjacent to the common electrode 270 and the second electrophoretic particles 316 are positioned adjacent to the respective pixel electrodes 190. Accordingly, most external light incident to the respective pixel areas A is reflected from the first electrophoretic particles 314 having a white color. Thereby, the respective pixel areas A display a third gray image of white that is the brightest as shown in FIG. 4, where the third gray image corresponds to the fourth image displayed at the pixel area A of the electrophoretic display.

As shown in FIG. 5, the first and second electrophoretic particles 314 and 316 of the respective pixel areas A are positioned between the pixel electrode 190 and the common electrode 270, and most of the first electrophoretic particles 314 are arranged adjacent to the common electrode 270. Accordingly, a large quantity of external light incident to the respective pixel areas A is reflected from the first electrophoretic particles 314 having a white color and a small quantity of external light incident to the respective pixel areas A is absorbed in the second electrophoretic particles 316 having a black color. Thereby, the respective pixel areas A display a second gray image that is darker than the third gray image, as shown in FIG. 6, where the second gray image corresponds to the third image displayed at the pixel areas A of the electrophoretic display.

As shown in FIG. 7, the first and second electrophoretic particles 314 and 316 of the respective pixel areas A are positioned between the pixel electrode 190 and the common electrode 270, and most of the second electrophoretic particles 316 are arranged adjacent to the common electrode 270. Accordingly, a small quantity of external light incident to the respective pixel areas A is reflected from the first electrophoretic particles 314 having a white color and a large quantity of external light incident to the respective pixel areas A is absorbed in the second electrophoretic particles 316 having a black color. Thereby, the respective pixel areas A display a first gray image that is darker than the second gray image as shown in FIG. 8, where the first gray image corresponds to the second image displayed at the pixel areas A of the electrophoretic display.

As shown in FIG. 9, the first electrophoretic particles 314 of the respective pixel areas A are arranged adjacent to the respective pixel electrodes 190 and the second electrophoretic particles 316 are arranged adjacent to the common electrode 270. Accordingly, most external light incident to the respective pixel areas A is absorbed in the second electrophoretic particles 316 having a black color. Thereby, the respective pixel areas A displays a zeroth gray image of black that is the darkest as shown in FIG. 10, where the zeroth gray image corresponds to the first image displayed at the pixel areas A of the electrophoretic display.

The electrophoretic particles 314 and 316 of the respective pixel areas A may be variously arranged such that the respective pixel areas A may display one gray image of the four gray images described above. Accordingly, the respective pixel areas A may display desired images by a combination of the four gray images described above.

Hereinafter, an exemplary driving method for the exemplary electrophoretic display according to an exemplary embodiment of the present invention will be described.

The driving voltages and the applying time of the voltages in various exemplary embodiments of the invention are defined as follows.

In addition, the driving voltages are values obtained by subtracting a data voltage applied to the pixel electrodes from a common voltage applied to the common voltage, which is defined as follows.

The reset voltage and the image displaying voltage V2 are negative (−) voltages that allow the first electrophoretic particles 314 to overcome fluid resistance caused by the dispersion medium 312 and move to the pixel electrodes 190, and allow the second electrophoretic particles 316 to overcome fluid resistance caused by the dispersion medium 312 and move to the common electrode 270.

The reset compensation voltage and the image displaying compensation voltage V1 are positive (+) voltages that allow the first electrophoretic particles 314 to overcome fluid resistance caused by the dispersion medium 312 and move to the common electrode 270, and allow the second electrophoretic particles 316 to overcome fluid resistance caused by the dispersion medium 312 and move to the pixel electrodes 190, and that have substantially the same value and opposite polarity to the reset voltage and the image displaying voltage V2.

In addition, the applying time of the voltages V1 and V2 is defined as follows. Here, the applying time is denoted as additional Arabic numbers and the magnitude of the small number does not represent a length of time or an order.

The first time T1 is a time needed for the first electrophoretic particles 314 and the second electrophoretic particles 316 to move adjacent to the pixel electrodes 190 and the common electrode 270, respectively, and be arranged by applying the reset voltage V1 as shown in FIG. 9.

The second time T2 is a time needed for the first electrophoretic particles 314 and the second electrophoretic particles 316 arranged adjacent to the pixel electrode 190 and the common electrode 270, respectively, to move to the common electrode 270 and the pixel electrode 190, respectively, by applying the reset compensation voltage V1 as shown in FIG. 3. Here, the length of the second time T2 may be substantially the same as that of the first time T1.

The third time T3 is a time needed for the first electrophoretic particles 314 and the second electrophoretic particles 316 arranged adjacent to the common electrode 270 and the pixel electrodes 190, respectively, to maintain the arrangement by applying the image displaying compensation voltage V1 and is a time needed for the pixel electrode 190 to be refreshed such that negative or positive electric charges may not be accumulated at the pixel electrode 190 when applying the image displaying voltage V2.

The fourth time T4 is a time needed for the first electrophoretic particles 314 and the second electrophoretic particles 316 arranged adjacent to the common electrode 270 and the pixel electrodes 190, respectively, to be arranged as shown in FIG. 5 or FIG. 7 by applying the image displaying voltage V2, or a time needed for the first electrophoretic particles 314 and the second electrophoretic particles 316 arranged adjacent to the common electrode 270 and the pixel electrodes 190, respectively, to move between the pixel electrode 190 and the common electrode 270 and be arranged as shown in FIG. 9 by applying the image displaying voltage V2. Here, the length of the fourth time T4 may be substantially the same as that of the third time T3. The length of the fourth time T4 may be about one third to two thirds of the first time T1 in case of an arrangement as shown in FIG. 5 and FIG. 7, and may be substantially the same as that of the first time T1 in the case of an arrangement as shown in FIG. 9.

Times Ta, Tb, Tc, and Td are times for not applying voltages V1 and V2 and occur between applications of voltages V1 and V2. The times Ta, Tb, Tc, and Td may be same or different, and may be omitted.

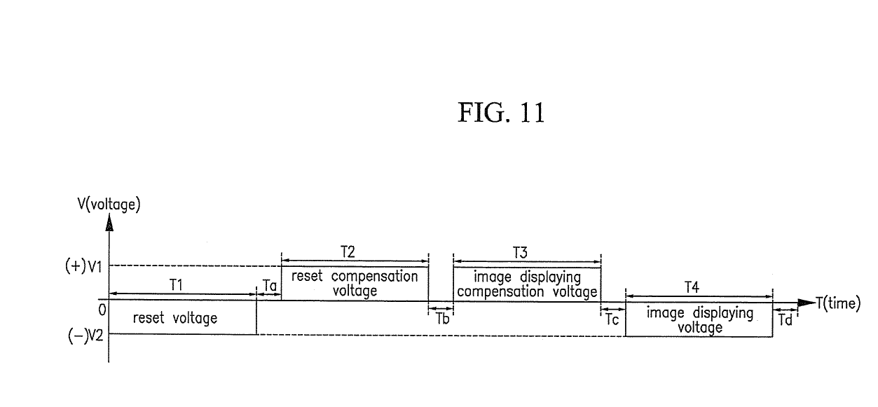

Hereinafter, an exemplary driving method for the exemplary electrophoretic display according to an exemplary embodiment of the present invention will be described referring to FIG. 11 along with FIG. 3 to FIG. 10.

FIG. 11 is a drawing representing driving voltages supplied to a pixel area of the exemplary electrophoretic display in a process of time for explaining an exemplary method for driving the exemplary electrophoretic display according to an exemplary embodiment of the present invention.

Firstly, as shown in FIG. 11, a reset voltage V2 is applied to the electrophoretic particles 314 and 316 of each pixel area A for the first time T1 such that each pixel area A displays a reset image.

As shown in FIG. 9, the first electrophoretic particles 314 of each pixel area A are moved and arranged to the respective pixel electrode 190 and the second electrophoretic particles 316 of each pixel area A are moved and arranged to the common electrode 270 by applying the reset voltage V2. Along with the arrangement of the electrophoretic particles 314 and 316, external light incident on the electrophoretic display through the common electrode panel 200 is absorbed in the second electrophoretic particles 316 having a black color.

Thereby, each pixel area A displays a zeroth gray image of black that is the darkest as shown in FIG. 10, and the entire display area of the electrophoretic display displays a black color image of an initial reset image.

Next, as shown in FIG. 11, after the first time T1 and the predetermined time Ta, the reset compensation voltage V1 is applied to the electrophoretic particles 314 and 316 of each pixel area A for the second time T2.

Accordingly, the first electrophoretic particles 314 of each pixel area A are moved and arranged to the common electrode 270 and the second electrophoretic particles 316 of each pixel area A are moved and arranged to the pixel electrode 190 as shown in FIG. 3 by applying the reset compensation voltage V1. Accordingly, an external light incident to each pixel area A is reflected from the first electrophoretic particles 314 having a white color.

Thereby, each pixel area A displays a third gray image of white that is the brightest as shown in FIG. 4, and the entire display area of the electrophoretic display displays white images.

Next, as shown in FIG. 11, after the second time T2 and a predetermined time Tb, the image displaying compensation voltage V1 is applied to the electrophoretic particles 314 and 316 positioned in portions of the whole pixel areas A for the third time T3. Here, the image displaying compensation voltage V1 is not applied to other portions of the whole pixel areas A, which may continually display a white color after the fourth time T4.

Here, the length of the third time T3 is determined by that of the fourth time T4 supplied for displaying a desired image, and the length of the third time T3 and the length of the fourth time T4 may be substantially the same. In addition, the length of the third time T3 and the length of the time T4 may be about one third to two thirds of the first time T1, or may be substantially the same as that of the first time T1.

The image displaying compensation voltage V1 has the same magnitude and polarity as the reset compensation voltage V1 such that the arrangement of the first and second electrophoretic particles 314 and 316 of the portions of the whole pixel areas A as shown in FIG. 3 is maintained constantly even though the image displaying compensation voltage V1 is applied for the third time T3. Accordingly, portions of the whole pixel areas A supplied with the image displaying compensation voltage V1 display continually a third gray image of white that is the brightest as shown in FIG. 4.

Meanwhile, the electrophoretic particles 314 and 316 positioned in the portions of the pixel areas A not supplied with the image displaying compensation voltage V1 are maintained in the arrangement as shown in FIG. 3. Accordingly, the portions of the whole pixel areas A not supplied with the image displaying compensation voltage V1 also continually display a third gray image of white (a fourth color) that is the brightest as shown in FIG. 4.

Thereby, the entire display area of the electrophoretic display may continually display a white image after the third time T3 without any inversed images.

Next, after the third time T3 and a predetermined time Tc, the image displaying voltage V2 is applied to the electrophoretic particles 314 and 316 of the pixel areas A supplied with the image displaying compensation voltage V1 to display desired images for the fourth time T4.

Here, the length of the fourth time T4 is substantially the same as that of the third time T3. If the length of the third time T3 may be about one third of the first time T1, the electrophoretic particles 314 and 316 of the pixel areas A supplied with the image displaying voltage V2 for the fourth time T4 being about one third of the first time T1 are arranged as shown in FIG. 5. Thereby, the pixel areas A supplied with the image displaying voltage V2 for the fourth time T4 display a second gray image (a third color) that is darker than the third gray image as shown in FIG. 6.

Meanwhile, If the length of the third time T3 may be about two thirds of the first time T1, the electrophoretic particles 314 and 316 of the pixel areas A supplied with the image displaying voltage V2 for the fourth time T4 being about two thirds of the first time T1 are arranged as shown in FIG. 7. Thereby, the pixel areas A supplied with the image displaying voltage V2 for the fourth time T4 display the first gray image (a second color) that is darker than the second gray image as shown in FIG. 8.

Likewise, If the length of the third time T3 may be substantially the same as that of the first time T1, the electrophoretic particles 314 and 316 of the pixel areas A supplied with the image displaying voltage V2 for the fourth time T4 being substantially the same as the first time T1 are arranged as shown in FIG. 9. Thereby, the pixel areas A supplied with the image displaying voltage V2 for the fourth time T4 display the zeroth gray image (a first color) that is darkest.

Meanwhile, the electrophoretic particles 314 and 316 positioned in the pixel areas A not supplied with the image displaying compensation voltage V1 are maintained in the arrangement as shown in FIG. 3 even though the image displaying voltage V2 is not applied to the pixel areas A. Accordingly, the pixel areas A not supplied with the image displaying compensation voltage V1 continually display the third gray image of white color (the fourth color).

Therefore, after the fourth time T4, each pixel area A may display any one of the gray image of the zeroth image to the third gray image such that the entire display area of the electrophoretic display may display desired images.

As described above, in the exemplary driving method for the exemplary electrophoretic display according to the exemplary embodiment of the present invention, the electrophoretic particles 314 and 316 positioned in the respective pixel areas A are supplied with the negative reset voltage V2 and the positive reset compensation voltage V1 for the same period, and are supplied with the positive image displaying compensation voltage V1 and the negative image displaying voltage V2 for the same period such that negative or positive electric charges may not be accumulated at the pixel electrode 190. Thereby, the pixel electrodes 190 of the respective pixel areas A are refreshed to prevent incidental images.

Further, the pixel areas A supplied with the reset compensation voltage V1 continually display white images as though the image displaying compensation voltage V1 is applied to the pixel areas before the image displaying voltage V2 such that the inversed image may not be displayed. Accordingly, the display performance of the electrophoretic display may be improved.

The driving process described above is repeated after a predetermined time Td for displaying a desired image and preventing incidental images.

The exemplary driving method for the exemplary electrophoretic display according to an exemplary embodiment of the present invention described above will be summarized briefly as follows.

Referring to FIG. 11, the reset voltage V2, the reset compensation voltage V1, the image displaying compensation voltage V1, and the image displaying voltage V2 are sequentially applied to the electrophoretic particles 314 and 316 of the pixel areas A between the predetermined time intervals Ta, Tb, Tc, and Td for the first time T1, the second time T2, the third time T3, and the fourth time T4 repeatedly.

Here, the reset voltage V2 has the same magnitude and opposite polarity to the reset compensation voltage V1 and the image displaying voltage V2 has the same magnitude and opposite polarity to the image displaying compensation voltage V1.

Accordingly, the integrated reset voltage V2 with the first time T1 is substantially the same as the integrated reset compensation voltage V1 with the second time T2, and the integrated image displaying compensation voltage V1 with the third time T3 is substantially the same as the integrated image displaying voltage V2 with the fourth time T4. Thereby, the pixel electrode 190 of each pixel area A may be refreshed to prevent an incidental image and such that no inversed images may occur to improve the display performance.

The above-described exemplary embodiment may be modified within the condition that the integrated reset voltage V2 with the first time T1 is substantially the same as the integrated reset compensation voltage V1 with the second time T2, and the integrated image displaying compensation voltage V1 with the third time T3 is substantially the same as the integrated image displaying voltage V2 with the fourth time T4.

Further, in an alternative exemplary embodiment, the reset voltage V2 may have the opposite polarity to that described above such that the initial images may be changed to the third gray image of the brightest instead of the zeroth gray image of the darkest.

The driving voltages V1 and V2 may also have the opposite polarity to that described above.

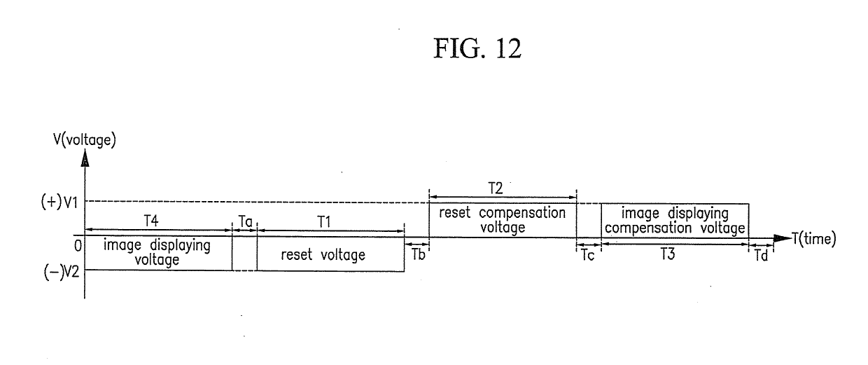

Hereinafter, an exemplary driving method for the exemplary electrophoretic display according to another exemplary embodiment of the present invention will be described referring to FIG. 12 along with FIG. 3 to FIG. 10.

FIG. 12 is a drawing representing driving voltages supplied to a pixel area of the exemplary electrophoretic display in a process of time for explaining an exemplary method for driving the exemplary electrophoretic display according to another exemplary embodiment of the present invention.

As shown in FIG. 12, the exemplary driving method according to the present embodiment is substantially the same as the previous embodiment shown in FIG. 11, except that the image displaying voltage V2 is applied before applying the reset voltage V2.

Generally, when the electrophoretic display is off by turning off the driving voltage, the electrophoretic display may be off in arrangement of the electrophoretic particles 314 and 316 of all pixel areas A as shown in FIG. 3. The driving method according to another exemplary embodiment of the present invention relates to the driving method used in turning on the driving voltage again after the electrophoretic display is off.

Firstly, the driving voltage is turned on after the electrophoretic display is off. Here, the image displaying voltage V2 for displaying a desired image is applied to the electrophoretic particles 314 and 316 of at least some of the pixel areas A for the fourth time T4 as shown in FIG. 12.

The electrophoretic particles 314 and 316 positioned in the pixel areas A supplied with the image displaying voltage V2 for the fourth time T4 are arranged as in one of FIG. 5, FIG. 7, and FIG. 9. Accordingly, the pixel areas A supplied with the image displaying voltage V2 for the fourth time T4 may display one gray image of the second gray image, the first gray image, and the zeroth gray image as shown in one of FIG. 6, FIG. 8, and FIG. 10.

Meanwhile, the electrophoretic particles 314 and 316 positioned in the pixel areas A not supplied with the image displaying voltage V2 maintain the arrangement as shown in FIG. 3. Accordingly, the pixel areas A not supplied with the image displaying voltage V2 display the third gray image as shown in FIG. 4.

Thereby, each respective pixel area A displays one gray image amongst the zeroth gray image to the third gray image after the fourth time T4. The entire display area including the plurality of pixel areas A may display the desired images.

Next, as shown in FIG. 12, the reset voltage V2 is applied to the electrophoretic particles 314 and 316 of all pixel areas A for the first time T1 after the fourth time T4 and a predetermined time Ta such that all pixel areas A may display one reset image.

As shown in FIG. 9, the first electrophoretic particles 314 of each pixel area A are moved and arranged to the respective pixel electrode 190 and the second electrophoretic particles 316 of each pixel area A are moved and arranged to the common electrode 270 by applying the reset voltage V2.

Thereby, each pixel area A displays a zeroth gray image of black that is the darkest as shown in FIG. 10, and the entire display areas of the electrophoretic display displays a black color image of an initial reset image.

Next, as shown in FIG. 12, after the first time T1 and a predetermined time Tb the reset compensation voltage V1 is applied to the electrophoretic particles 314 and 316 of each pixel area A for the second time T2.

Accordingly, the first electrophoretic particles 314 of each pixel area A are moved and arranged to the common electrode 270 and the second electrophoretic particles 316 of each pixel area A are moved and arranged to the respective pixel electrode 190 as shown in FIG. 3 by applying the reset compensation voltage V1.

Thereby, each pixel area A displays a third gray image of white that is the brightest as shown in FIG. 4, and the entire display area of the electrophoretic display displays white images.

Next, as shown in FIG. 12, after the second time T2 and a predetermined time Tc, the image displaying compensation voltage V1 is applied to the electrophoretic particles 314 and 316 positioned in the portions of the whole pixel areas A supplied with the image displaying voltage V2 for the third time T3.

The image displaying compensation voltage V1 has the same magnitude and polarity as the reset compensation voltage V1 such that the arrangement of the first and second electrophoretic particles 314 and 316 of the portions of the whole pixel areas A as shown in FIG. 3 is maintained constantly even though the image displaying compensation voltage V1 is applied for the third time T3.

Accordingly, the portions of the whole pixel areas A supplied with the image displaying compensation voltage V1 continually display a third gray image of white that is the brightest as shown in FIG. 4. Meanwhile, the electrophoretic particles 314 and 316 positioned in the portions of the pixel areas A not supplied with the image displaying compensation voltage V1 are maintained in the arrangement as shown in FIG. 3. Accordingly, the portions of the whole pixel areas A not supplied with the image displaying compensation voltage V1 also continually display a third gray image of white that is the brightest as shown in FIG. 4.

Thereby, all display areas of the electrophoretic display may continually display a white image after the third time T3 without any inversed images.

As described above, positive or negative electric charges may be accumulated at each pixel electrode before the electrophoretic display is on. However, in the exemplary driving method for the electrophoretic display according to the embodiment of the present invention, the electrophoretic particle 314 and 316 positioned in the respective pixel areas A are supplied with the negative reset voltage V2 and the positive reset compensation voltage V1 for the same period, and are supplied with the positive image displaying compensation voltage V1 and the negative image displaying voltage V2 for the same period such that negative or positive electric charges may not be accumulated at the respective pixel electrode 190. Thereby, positive or negative electric charges may not be accumulated at each pixel electrode 190 and the accumulated charges may be removed such that the pixel electrodes 190 of the respective pixel areas A are refreshed to prevent incidental images.

Further, the pixel areas A supplied with the reset compensation voltage V1 after being supplied with the image displaying voltage V2 continually display white images, and the pixel area A may continually display white images as though the reset compensation voltage V1 is applied. Accordingly, the inversed images may not occur as though the image displaying compensation voltage V1 is applied such that the display performance of the electrophoretic display may be improved.

In the described embodiments of the present invention, even though the electrophoretic display displays four gray images of the zeroth to third gray images, the electrophoretic display may display additional gray images, such as 8 grays or 16 grays, by subdividing the magnitude of the voltages V1 and V2 or the applying time of the voltages V1 and V2.

In addition, the electrophoretic member 300 of the electrophoretic display may just include a dispersion medium 312 of a black color and the electrophoretic particles 314 having a white color.

In addition, the first electrophoretic particles 314 may have one color of red, green, and blue instead of white, and first electrophoretic particles 314 having a red color, first electrophoretic particles 314 having a green color, and first electrophoretic particles 314 having a blue color may be respectively arranged in one pixel area in turns such that the electrophoretic display may display various color images. Here, the first electrophoretic particles 314 having one color of red, green, and blue may be dispersed within a dispersion medium 312 along with the second electrophoretic particles 316 of a black color. Also, the first electrophoretic particles 314 may have one color of yellow, magenta, and cyan instead of red, green, and blue.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method for an electrophoretic display including a plurality of first electrodes, a second electrode, and electrophoretic particles positioned in a plurality of pixel areas between the first electrodes and the second electrode, the driving method comprising:
applying a reset voltage to the electrophoretic particles for a set time;
applying a reset compensation voltage having an opposite polarity to that of the reset voltage to the electrophoretic particles for a set time;
applying an image displaying compensation voltage to the electrophoretic particles positioned in at least one of the pixel areas for a set time; and
applying an image displaying voltage having an opposite polarity to that of the image displaying compensation voltage to the electrophoretic particles positioned in the at least one of the pixel areas for a set time.

2. The driving method of claim 1, wherein the image displaying voltage is applied to the electrophoretic particles positioned in the at least one of the pixel areas supplied with the image displaying compensation voltage after applying the image displaying compensation voltage.

3. The driving method of claim 1, wherein the image displaying voltage is applied to the electrophoretic particles positioned in the at least one of the pixel areas before applying the reset voltage.

4. The driving method of claim 3, wherein the image displaying compensation voltage is applied to the electrophoretic particles positioned in pixel areas supplied with the image displaying voltage.

5. The driving method of claim 1, wherein a value of integrating the reset voltage with applying time thereof is substantially same as that of integrating the reset compensation voltage with applying time thereof.

6. The driving method of claim 1, wherein a value of integrating the image displaying compensation voltage with applying time thereof is substantially same as that of integrating the image displaying voltage with applying time thereof.

7. The driving method of claim 1, wherein the reset voltage and the reset compensation voltage have a substantially same magnitude.

8. The driving method of claim 1, wherein the image displaying compensation voltage and the image displaying voltage have a substantially same magnitude.

9. The driving method of claim 1, wherein the reset voltage and the image displaying voltage have a substantially same magnitude.

10. The driving method of claim 1, wherein the pixel areas:
display a first color image by applying the reset voltage;
display a second color image by applying the reset compensation voltage;
display the second color image by applying the image displaying compensation voltage; and
display at least one color image of the first color image or a second color image by applying the image displaying voltage.

11. The driving method of claim 1, wherein the pixel areas:
display a first color image by applying the reset voltage;
display a second color image by applying the reset compensation voltage;
display the second color image by applying the image displaying compensation voltage; and
display at least one color image of the first color image, a second color image or a third color image by applying the image displaying voltage.

12. The driving method of claim 11, wherein the first color image is a black color image, the second color image is a white color image, the third color image is brighter than the first color image.

13. The driving method of claim 12, wherein the pixel areas:
display at least one color image of the first color image, a second color image, a third color of forth color image by applying the image displaying voltage.

14. The driving method of claim 13, wherein the forth color image is brighter than the third color image.

15. The driving method of claim 14, wherein an applying time of the reset voltage is a first time needed for a plurality of the pixel areas to display the first color image, an applying time of the reset compensation voltage is a second time needed for a plurality of the pixel areas to display the second color image, an applying time of the image displaying compensation voltage is a third time, and an applying time of the image displaying voltage is a fourth time needed for a plurality of the pixel areas to display at least one color image of the first color image to the fourth color image, and
a value of integrating the image displaying compensation voltage with the third time is substantially same as that of integrating the image displaying compensation voltage with the fourth time.

16. The driving method of claim 15, wherein the first time is substantially same as the second time.

17. The driving method of claim 15, wherein the third time is substantially same as the fourth time.

18. The driving method of claim 1, wherein the pixel areas:
display a first color image by applying the reset voltage, respectively;
display a sixteenth color image by applying the reset compensation voltage, respectively;
display the sixteenth color image by applying the image displaying compensation voltage, respectively; and
display one color image of the first color image to the sixteenth color image by applying the image displaying voltage, respectively.

19. The driving method of claim 18, wherein the first color image is a black color image, the sixteenth color image is a white color image, and color images displayed by the pixel areas become brighter from the first color image to the sixteenth color image.

20. The driving method of claim 18, wherein an applying time of the reset voltage is a first time needed for a plurality of the pixel areas to display the first color image, an applying time of the reset compensation voltage is a second time needed for a plurality of the pixel areas to display the sixteenth color image, an applying time of the image displaying compensation voltage is a third time, and an applying time of the image displaying voltage is a fourth time needed for a plurality of the pixel areas to display at least one color image of the first color image to the sixteenth color image, and
a value of integrating the image displaying compensation voltage with the third time is substantially same as that of integrating the image displaying compensation voltage with the fourth time.
